(19) United States
(12) Patent Application Publication
(10) Pub. No.: US 2022/0411570 A1
(43) Pub. Date: Dec. 29, 2022

(54) METHOD FOR PRODUCING A THERMOPLASTIC POLYURETHANE WITH LOW MELT ENTHALPY

(71) Applicant: Covestro Intellectual Property GmbH & Co. KG, Leverkusen (DE)

(72) Inventors: Bernd GARSKA, Köln (DE); Daniel RAPS, Leverkusen (DE); Thomas KOENIG, Leverkusen (DE); Rainer BELLINGHAUSEN, Odenthal (DE); Thomas PRENVEILLE, Ecardenville-La-Campagne (FR); Claudia HOUBEN, Heinsberg (DE); Mathias MATNER, Neuss (DE)

(21) Appl. No.: 17/781,126

(22) PCT Filed: Dec. 10, 2020
(86) PCT No.: PCT/EP2020/085510

§ 371 Date: May 31, 2022

(30) Foreign Application Priority Data
Dec. 17, 2019 (EP) 19216825.0

(51) Int. Cl. C08G 18/73; C08G 18/32; C08G 18/10; C08G 18/08

(52) U.S. Cl. CPC C08G 18/73; C08G 18/3206; C08G 18/10; C08G 18/0895

(57) ABSTRACT

The invention relates to a method for producing a thermoplastic polyurethane (G) using a reactive extrusion process, having the steps of: a) mixing a polyisocyanate stream (A) and a polyol stream (B) in a first mixing device (7) such that a mixture stream (C) is obtained, the mass flow rates of the polyisocyanate stream (A) and the polyol stream (B) being set such that the isocyanate index in the mixture stream (C) ranges from 55 to 85, b) introducing the mixture stream (C) into a circulating stream (D) which is conducted in a circular flow, the monomers of the polyisocyanates stream (A) and the polyol stream (B) in the circulating stream (D) being further reacted into OH-functional pre-polymers, c) separating a sub-stream from the circulating stream (D) as a prepolymer stream (E) and introducing same into an extruder (18), d) introducing an isocyanate feed stream (F) into the extruder (18) downstream of the introduction point of the prepolymer stream (E) in the extruder working direction, wherein the introduction process is carried out such that the OH-functional prepolymers contained in the prepolymer stream (E) and the polyisocyanate contained in the isocyanate feed stream (F) are in an isocyanate index of 85 to 120, and e) reacting the prepolymer stream (E) with the isocyanate feed stream (F) in the extruder (18), thereby obtaining the thermoplastic polyurethane (G) as the extrudate.

The present invention relates to a process for preparing a thermoplastic polyurethane having a low enthalpy of fusion and also to the thermoplastic polyurethane thus obtained and to the use thereof

Thermoplastic polyurethanes are largely unbranched macromolecules. They are usually obtained by reacting bifunctional isocyanates, long-chain diols, such as for example polyethers or polyesters, and chain extenders with one another. There are various industrial processes for preparing thermoplastic polyurethane (TPU), with a distinction being made between discontinuous batch processes and continuous processes. One continuous process is reactive extrusion, in which the starting materials used for the preparation are introduced into an extruder. Reactive extrusion should be distinguished from the use of an extruder purely for the processing of plastics. In reactive extrusion, the starting materials are mixed by the rotary movements of the screw of the extruder and react with one another with the result that a polymer melt is obtained. This polymer melt is then extruded and the extrudate strands obtained, possibly after cooling in a water bath, are chopped into pellets or brought directly into a specific form. When processing TPU in an extruder, pellets of already synthesized TPU are melted in the extruder and the melt is extruded.

If a TPU is remelted, inhomogeneities may arise in the polymer melt during the melting as a result of the fact that a portion of the pellets have already melted, but another portion have not yet melted. Inhomogeneous polymer melts pose problems in the processing in the extruder since unmelted, largely solid or gel-like portions move more slowly in the extruder than already melted TPU, which forms a largely liquid or viscous polymer melt. The largely solid portions can also accumulate in the extruder and become detached again in batches and lead to impurities in the polymer melt.

The melting characteristics of TPU are influenced by the ratio of soft and hard segments in the polymer. Here, hard segments are understood to mean the urethane units of the polyurethane and soft segments are understood to mean the polyol chains. In a cured, cooled TPU, soft and hard segments are arranged in a polymeric two-phase system. In this system, the adjacent domains in the hard segments are associated via hydrogen bonds and form crystalline structures. The ends of the polymer chains constitute defects which cannot be incorporated into the crystalline structures. In order to melt TPU having a relatively low degree of crystallization, less energy needs to be applied than for melting TPU with a high degree of crystallization, that is to say that the enthalpy of fusion for a TPU with a comparatively high molecular weight is lower than that for a TPU with a comparatively low molecular weight.

CN 10 714 1437 relates to TPU intended to be used in 3D printing processes. The document discloses a synthesis by reactive extrusion and teaches that the enthalpy of fusion of a TPU can be influenced by the addition of a chain extender, wherein the chain extender is a cyclodextrin derivative.

CN 10 500 1626 likewise discloses a process for the reactive extrusion of polyurethane. The document discloses that the flow properties of the TPU can be influenced by addition of a mixture of diphenylsilyl glycol and ethylene glycol.

US 2017/145146 relates to TPU formed from components originating from renewable plant resources. The document discloses synthesis in a batchwise process and teaches that the melting temperature of a TPU depends inter alia on the isocyanate index and on the polymerization time.

An object of the present invention is that of providing a process and an apparatus for preparing a thermoplastic polyurethane having a mass-average molecular weight of preferably 50 000 g/mol to 70 000 g/mol, wherein the thermoplastic polyurethane according to the invention is intended to have a lower enthalpy of fusion compared to thermoplastic polyurethane prepared by conventional preparation methods and having comparable mass-average molecular weight.

This object has been achieved by a process for preparing a thermoplastic polyurethane by means of reactive extrusion, comprising the following steps:
a) mixing a polyisocyanate stream and a polyol stream in a first mixing device to obtain a mixed stream, wherein the mass flow rates of the polyisocyanate stream and of the polyol stream are adjusted such that the isocyanate index in the mixed stream is from 55 to 85,
b) introducing the mixed stream into a circulation stream which is circulated, wherein the monomers of the polyisocyanate stream and of the polyol stream react further in the circulation stream to give OH-functional prepolymers,
c) separating a substream from the circulation stream as prepolymer stream and introducing it into an extruder,
d) introducing an isocyanate feed stream into the extruder downstream of the introduction of the prepolymer stream in the working direction of the extruder, wherein the introduction is such that the OH-functional prepolymers present in the prepolymer stream and the polyisocyanate present in the isocyanate feed stream are in an isocyanate index of 85 to 120 with respect to one another,
e) reacting the prepolymer stream with the isocyanate feed stream in the extruder to obtain the thermoplastic polyurethane as extrudate.

It has surprisingly been found that the reactive extrusion process according to the invention with upstream circulation for preparing a prepolymer affords a thermoplastic polyurethane which has a lower enthalpy of fusion than thermoplastic polyurethane that has been prepared by a conventional batch process, wherein independently of the preparation process the polyurethanes have mass-average molecular weights that differ from one another only slightly. The lower enthalpy of fusion for the same molecular weight is advantageous since thermoplastic polyurethanes are generally melted in the later processing to give the end product, and with a lower enthalpy of fusion the energy expended for this is lower, for which reason energy and hence production costs can be saved.

In step a) of the process according to the invention, a polyisocyanate stream and a polyol stream are mixed with one another in a first mixing device to obtain a mixed stream. The polyisocyanate stream preferably contains or consists of hexamethylene 1,6-diisocyanate. The polyol stream preferably contains or consists of butane-1,4-diol. Preferably, the polyisocyanate stream has a temperature of 20° C. to 25° C. and, independently of this, the polyol stream a temperature of 35° C. to 45° C. The mass flow rates of the polyisocyanate stream and of the polyol stream are adjusted such that the isocyanate index in the mixed stream is from 55 to 85.

The isocyanate index (also called index) is understood to mean the quotient of the molar amount [mol] of isocyanate groups actually used and the molar amount [mol] of isocyanate-reactive groups actually used, multiplied by 100:

index=(moles of isocyanate groups/moles of isocyanate-reactive groups)*100

The NCO value (also known as NCO content, isocyanate content) is determined according to EN ISO 11909:2007. The values are at 25° C. unless stated otherwise.

In a preferred embodiment, the polyol stream can already be combined with the polyisocyanate stream upstream of the first mixing device. In another embodiment, the polyol stream and the polyisocyanate stream are passed into the first mixing device independently of one another. The first mixing device is preferably a static mixer.

In step b), the mixed stream is introduced into a circulation stream which is circulated, wherein the monomers of the polyisocyanate stream and of the polyol stream react further in the circulation stream to give OH-functional prepolymers. In step c), a substream is separated from the circulation stream as prepolymer stream and is introduced into an extruder.

Thus, monomers of the polyisocyanate stream and of the polyol stream are fed to the circulation stream and OH-functional prepolymer is withdrawn from the circulation stream. The circulation stream thus contains a mixture of monomers of the polyisocyanate stream and of the polyol stream and also of oligomeric reaction products and of the prepolymer. During the passage through the circuit, the monomers react both with one another and with the oligomeric reaction products of these monomers already present in the circulation stream. Consequently, a continuous reaction takes place in the circulation stream to obtain the OH-functional prepolymer. Some prepolymers may preferably pass through the circulation stream multiple times before they are separated as a substream. This is advantageous because the circulation regime already removes a large part of the overall heat of reaction released and the temperature can be better controlled than when the reactants are supplied directly to the extruder.

The circulation stream preferably passes through at least two mixing devices, at least one in particular being a temperature-controllable mixing device. Preferably, the circulation stream has a temperature of 160° C. to 220° C., more preferably of 170° C. to 190° C.

In step c), the prepolymer stream is preferably introduced into the extruder on the inlet side of the extruder. Prior to the introduction of the prepolymer stream into the extruder, gases and gaseous byproducts are preferably removed from the prepolymer stream. In one embodiment, gases and gaseous byproducts are removed by passing the prepolymer stream through a venting device with a negative pressure of 0.1 to 10 mbar below standard pressure, wherein the venting device is preferably arranged on the extruder. Gases and gaseous byproducts are preferably removed by atmospheric devolatilization, that is to say by a venting device arranged on the extruder without a negative pressure being applied.

In step d), an isocyanate feed stream is introduced into the extruder downstream of the introduction of the prepolymer stream in the working direction of the extruder, wherein the introduction is such that the OH-functional prepolymers present in the prepolymer stream and the polyisocyanate present in the isocyanate feed stream are in an isocyanate index of 85 to 120 with respect to one another. The polyisocyanate stream and/or the isocyanate feed stream preferably contain or consist of hexamethylene 1,6-diisocyanate. In particular, the polyisocyanate stream and the isocyanate feed stream contain or consist of hexamethylene 1,6-diisocyanate. Preferably, the polyisocyanate stream and the isocyanate feed stream contain or consist of hexamethylene 1,6-diisocyanate and the polyol stream contains or consists of butane-1,4-diol.

In step e), the prepolymer stream is reacted with the isocyanate feed stream in the extruder to obtain the thermoplastic polyurethane as extrudate. In the extruder, as a result of the movements of the conveying elements within the extruder, the two components are both mixed and conveyed in the direction of an outlet opening of the extruder downstream in the working direction of the extruder. In the process, the components react with one another in a continuous process with the result that the thermoplastic polyurethane is obtained. The viscosity of the components situated in the extruder preferably increases in the working direction of the extruder as the degree of polymerization progresses. In the region of the inlet openings for the prepolymer stream and the isocyanate feed stream, there is in the extruder preferably a mixture having a low viscosity, which can be described as a liquid, whereas just before the exit from the extruder there is preferably a polymer melt which has a higher viscosity than the prepolymer stream and the isocyanate feed stream, and which can be described as viscous. The extruder is preferably a co-rotating twin-screw extruder. The reaction in step e) is conducted at a temperature of preferably 150° C. to 220° C., more preferably of 180° C. to 200° C.

The polyisocyanates used in the process according to the invention and/or the precursor compounds thereof may have been obtained from fossil or biological sources. Preference is given to preparing 1,6-diisocyanatohexane (HDI) from hexamethylene-1,6-diamine and 1,5-diisocyanatopentane from pentamethylene-1,5-diamine, with hexamethylene-1,6-diamine and pentamethylene-1,5-diamine having been obtained from biological sources, preferably by bacterial fermentation. The polyols used in the process according to the invention and/or the precursor compounds thereof may have been obtained from fossil or biological sources.

In a preferred embodiment, gases and gaseous byproducts are removed from the thermoplastic polyurethane by applying a negative pressure of 50 mbar to 500 mbar, more preferably of 80 to 300 mbar, more preferably still of 100 mbar to 250 mbar, in each case below standard pressure, at a devolatilization shaft which is preferably arranged in the last third of the extruder in the working direction of the extruder. To this end, a devolatilization dome is preferably arranged on the devolatilization shaft.

In a preferred embodiment of the process according to the invention, a devolatilizing extruder is arranged in the devolatilization shaft, on which devolatilizing extruder a vacuum dome is located and a negative pressure of 300 mbar to 500 mbar below standard pressure is applied. The devolatilizing extruder is preferably a screw extruder in which the running direction of the screws is set such that it conveys the polymer melt or thermoplastic polyurethane, which is drawn from the extruder into the devolatilization shaft as a result of the negative pressure, back into the extruder.

In a further embodiment, there is arranged in the devolatilization shaft of the extruder a retention device on which a vacuum dome is located and applies a negative pressure of 250 mbar to 350 mbar, more preferably of 280 mbar to 320 mbar, in each case below standard pressure. In this embodiment, a twin-screw extruder is used to perform the process and the opening of the devolatilization shaft to the extruder has an elongate form and is perpendicular to the axis of the twin screws, so that a portion of both twin screws is covered by the opening. The retention device is preferably designed such that its opening oriented toward the extruder covers the region of the upwardly rotating screw and of the intermeshing zone so that in this region no polymer melt or thermoplastic polyurethane, which is drawn from the extruder into the devolatilization shaft as a result of the negative pressure, can penetrate. Above the uncovered region of the opening of the retention device, a shaft preferably leads obliquely counter to the direction of rotation of the uncovered screw away in the direction of the vacuum dome. Thus, polymer melt or thermoplastic polyurethane which is drawn into the retention device impacts against the oblique shaft and falls back down into the extruder and is drawn back into the extruder by the rotary movement of the screws in the extruder. The area in which the two screws mesh is referred to here as the intermeshing zone. In twin-screw extruders, the two screw elements do not touch but are designed to mesh with one another. The area in which the two screws mesh is called the intermeshing zone. The screw whose rotational movement is directed away from the housing of the extruder toward the region between the two axes of the screw elements is referred to as the upwardly rotating screw.

In the context of the invention, standard pressure is understood to mean a pressure of 101 325 Pa=1.01325 bar.

The process preferably comprises the following additional steps:
f) cooling the thermoplastic polyurethane to a temperature below its melting point in a cooling device, the cooling device preferably being a water bath,
g) comminuting the thermoplastic polyurethane in a comminution device.

Here, the cooling of the thermoplastic polyurethane affords a solid which is comminuted in the comminution device preferably to give pellets. These pellets can be melted in an extrusion process for further processing and the polymer melt obtained by the melting can be processed into a molding, for example by injection into a mold.

A further embodiment of the invention relates to a thermoplastic polyurethane obtainable or obtained by the process according to the invention. The thermoplastic polyurethane obtained by the process according to the invention preferably has a mass-average molecular weight M_{w} of 50 000 g/mol to 70 000 g/mol determined by gel permeation chromatography, in which the sample was dissolved in a solution of potassium trifluoroacetate in hexafluoroisopropanol at a concentration of 2 mg/cm³ and a polymethylmethacrylate standard was used, and an enthalpy of fusion ΔH_{fus} of 60 J/g to 100 J/g determined by differential thermal analysis in accordance with DIN EN ISO 11357-1:2017-02 at a heating rate of 10 K/min in the range from 20° C. to 250° C., wherein M_{w}=ΔH_{fus}*f, where f is a number from 600 to 900, preferably from 625 to 900, more preferably from 650 to 850, more preferably still from 700 to 850.

In a further embodiment, the invention relates to the use of a thermoplastic polyurethane in a shaping process involving melting of the thermoplastic polyurethane, in particular for the production of vehicle interior components.

A further embodiment of the invention relates to an apparatus for performing the process according to the invention, comprising

an isocyanate reservoir vessel from which an isocyanate conduit for conveying a polyisocyanate stream departs, which isocyanate conduit opens into a first mixing device;
optionally a first conveying device assigned to the isocyanate conduit for conveying the polyisocyanate stream;
optionally a first mass flow meter connected to the isocyanate conduit;
a polyol reservoir vessel from which a polyol conduit for conveying a polyol stream departs, which polyol conduit opens into the first mixing device, where the polyol conduit is especially merged with the isocyanate conduit upstream of the first mixing device;
optionally a second conveying device assigned to the polyol conduit for conveying the polyol stream;
optionally a second mass flow meter connected to the polyol conduit;
a circulation feed conduit for conveying the mixed stream which exits from the first mixing device, which circulation feed conduit opens into a circulation conduit for conveying the circulation stream and chemically reacting the components of the circulation stream with the components of the mixed stream;
wherein the circulation conduit preferably comprises, in flow direction, a second mixing device, a temperature-controllable mixing device and a temperature-controllable conveying device;
a prepolymer feed conduit for conveying a prepolymer stream, which departs from the circulation conduit and opens into an extruder at the inlet side;
a pressure control valve provided in the prepolymer feed conduit for regulating the pressure of the prepolymer stream;
a three-way valve which is arranged in the prepolymer feed conduit and especially downstream of the pressure control valve, and from which a waste conduit which opens into a waste vessel departs, via which waste conduit the prepolymer stream can be guided wholly or partly into the waste vessel, especially in the event of startup, shutdown or a fault in the apparatus;
a venting device which is preferably arranged at the opening of the prepolymer feed conduit into the extruder for removal of gases and gaseous byproducts from the prepolymer stream;
an isocyanate feed conduit which departs from the isocyanate reservoir vessel or isocyanate conduit and opens into the extruder, preferably downstream of the prepolymer feed conduit in the working direction of the extruder, for conveying an isocyanate feed stream;
optionally a third conveying device assigned to the isocyanate feed conduit for conveying the isocyanate feed stream;
optionally a third mass flow meter connected to the isocyanate feed conduit;
wherein the extruder is suitable for reaction of the components of the prepolymer stream with the components of the isocyanate feed stream to give a thermoplastic polyurethane, and this has an assigned devolatilization shaft for removal of gases and gaseous byproducts by means of reduced pressure from this reaction, wherein the devolatilization shaft is preferably arranged in the last third of the extruder in the working direction of the extruder;
optionally a cooling device arranged beyond the outlet from the extruder, preferably a water bath, for cooling of the thermoplastic polyurethane to a temperature below its melting point;
optionally a comminution device that adjoins the cooling device, for comminution of the cooled thermoplastic polyurethane.

In a preferred embodiment of the apparatus, the polyol conduit opens into the first mixing device, i.e. it does not open into the isocyanate conduit upstream of the first mixing device.

Preferably, as first conveying device and/or as second conveying device, independently of one another, an annular gear pump is used and/or, as temperature-controllable conveying device, a gear pump is used.

Preferably, as first and/or second mixing device and/or as temperature-controllable mixing device, independently of one another, a static mixer is used.

The circulation conduit preferably consists of jacketed conduits heatable with a heating medium, wherein preferably the second mixing device, the temperature-controllable mixing device and the temperature-controllable conveying device are also heatable with a heating medium. In this case, the heating medium is preferably suitable for a heating temperature of 160° C. to 220° C., more preferably of 170° C. to 190° C.

In a preferred embodiment, the apparatus comprises a devolatilization dome which is arranged on the devolatilization shaft and is suitable for applying a negative pressure of 50 mbar to 500 mbar, more preferably of 80 mbar to 300 mbar, more preferably still of 100 mbar to 250 mbar, in each case below standard pressure.

In a preferred embodiment, the apparatus comprises a devolatilizing extruder which is arranged in the devolatilization shaft and on which there is located a vacuum dome. The devolatilizing extruder and the vacuum dome are suitable for applying a negative pressure of 300 mbar to 500 mbar below standard pressure. The devolatilizing extruder is preferably a screw extruder in which the running direction of the screws is set such that it conveys the polymer melt or thermoplastic polyurethane, which is drawn from the extruder into the devolatilization shaft as a result of the negative pressure, back into the extruder. The devolatilizing extruder is preferably arranged in the devolatilization shaft in such a way that the screws of the devolatilizing extruder have only a distance of 0.5 cm to 5 cm, preferably 0.8 cm to 2.5 cm, more preferably 1 cm to 2 cm, in each case from the screws of the extruder in which the polymerization takes place.

In a further embodiment, the apparatus comprises a retention device which is arranged in the devolatilization shaft of the extruder and on which there is located a vacuum dome. The retention device and the vacuum dome are suitable for applying a negative pressure of 250 mbar to 350 mbar, more preferably of 280 mbar to 320 mbar, in each case below standard pressure. In this embodiment, the extruder is a twin-screw extruder and the opening of the devolatilization shaft to the extruder has an elongate form and is perpendicular to the axis of the twin screws, so that a portion of both twin screws is covered by the opening. The retention device is preferably designed such that its opening oriented toward the extruder covers the region of the upwardly rotating screw and of the intermeshing zone so that in this region no polymer melt or thermoplastic polyurethane, which is drawn from the extruder into the devolatilization shaft as a result of the negative pressure, can penetrate. Above the uncovered region of the opening of the retention device, a shaft preferably leads obliquely counter to the direction of rotation of the uncovered screw away in the direction of the vacuum dome. Thus, polymer melt or thermoplastic polyurethane which is drawn into the retention device impacts against the oblique shaft and falls back down into the extruder and is drawn back into the extruder by the rotary movement of the screws in the extruder.

Preferably, the extruder is a planetary roller extruder or a screw extruder, the extruder more preferably being a co-rotating twin-screw extruder.

A further embodiment of the invention relates to a thermoplastic polyurethane which has a mass-average molecular weight M_{w} of 50 000 g/mol to 70 000 g/mol determined by gel permeation chromatography, in which the sample was dissolved in a solution of potassium trifluoroacetate in hexafluoroisopropanol at a concentration of 2 mg/cm³ and a polymethylmethacrylate standard was used, and an enthalpy of fusion ΔH_{fus} of 60 J/g to 100 J/g determined by differential thermal analysis in accordance with DIN EN ISO 11357-1:2017-02 at a heating rate of 10 K/min in the range from 20° C. to 250° C., wherein M_{w}=ΔH_{fus}*f, where f is a number from 600 to 900, preferably from 625 to 900, more preferably from 650 to 850, more preferably still from 700 to 850.

The invention especially relates to the following embodiments:

In a first embodiment, the invention relates to a process for preparing a thermoplastic polyurethane by means of reactive extrusion, comprising the following steps:
a) mixing a polyisocyanate stream and a polyol stream in a first mixing device to obtain a mixed stream, wherein the mass flow rates of the polyisocyanate stream and of the polyol stream are adjusted such that the isocyanate index in the mixed stream is from 55 to 85,
b) introducing the mixed stream into a circulation stream which is circulated, wherein the monomers of the polyisocyanate stream and of the polyol stream react further in the circulation stream to give OH-functional prepolymers,
c) separating a substream from the circulation stream as prepolymer stream and introducing it into an extruder,
d) introducing an isocyanate feed stream into the extruder downstream of the introduction of the prepolymer stream in the working direction of the extruder, wherein the introduction is such that the OH-functional prepolymers present in the prepolymer stream and the polyisocyanate present in the isocyanate feed stream are in an isocyanate index of 85 to 120 with respect to one another,
e) reacting the prepolymer stream with the isocyanate feed stream in the extruder to obtain the thermoplastic polyurethane as extrudate.

In a second embodiment, the invention relates to a process according to embodiment 1, wherein the polyisocyanate stream and/or the isocyanate feed stream contain or consist of hexamethylene 1,6-diisocyanate, wherein in particular the polyisocyanate stream and the isocyanate feed stream contain or consist of hexamethylene 1,6-diisocyanate.

In a third embodiment, the invention relates to a process according to embodiment 1 or 2, wherein the polyol stream contains or consists of butane-1,4-diol.

In a fourth embodiment, the invention relates to a process according to any of embodiments 1 to 3, wherein the polyisocyanate stream has a temperature of 20° C. to 25° C. and, independently of this, the polyol stream a temperature of 35° C. to 45° C.

In a fifth embodiment, the invention relates to a process according to any of embodiments 1 to 4, wherein, prior to the introduction of the prepolymer stream into the extruder, gases and gaseous byproducts are removed from the prepolymer stream, preferably by passing the prepolymer stream through a venting device at a negative pressure of 0.1 mbar to 10 mbar below standard pressure, wherein the venting device is preferably arranged on the extruder.

In a sixth embodiment, the invention relates to a process according to any of embodiments 1 to 5, wherein the reaction in step e) is conducted at a temperature of 150° C. to 280° C., preferably of 180° C. to 260° C.

In a seventh embodiment, the invention relates to a process according to any of embodiments 1 to 6, wherein gases and gaseous byproducts are removed from the thermoplastic polyurethane by applying a negative pressure of 50 mbar to 500 mbar below standard pressure at a devolatilization shaft which is preferably arranged in the last third of the extruder in the working direction of the extruder.

In an eighth embodiment, the invention relates to a process according to any of embodiments 1 to 7, wherein the process comprises the following additional steps:
f) cooling the thermoplastic polyurethane to a temperature below its melting point in a cooling device,
g) comminuting the thermoplastic polyurethane in a comminution device.

In a ninth embodiment, the invention relates to a thermoplastic polyurethane obtainable or obtained by a process according to any of embodiments 1 to 8.

In a tenth embodiment, the invention relates to a thermoplastic polyurethane according to embodiment 9, wherein the thermoplastic polyurethane has a mass-average molecular weight M_{w} of 50 000 g/mol to 70 000 g/mol determined by gel permeation chromatography, in which the sample was dissolved in a solution of potassium trifluoroacetate in hexafluoroisopropanol at a concentration of 2 mg/cm³ and a polymethylmethacrylate standard was used, and an enthalpy of fusion ΔH_{fus} of 60 J/g to 100 J/g determined by differential thermal analysis in accordance with DIN EN ISO 11357-1:2017-02 at a heating rate of 10 K/min in the range from 20° C. to 250° C., wherein M_{w}=ΔH_{fus}*f, where f is a number from 600 to 900, preferably from 625 to 900, more preferably from 650 to 850, more preferably still from 700 to 850.

In an eleventh embodiment, the invention relates to the use of a thermoplastic polyurethane according to either of embodiments 9 or 10 in a shaping process involving melting of the thermoplastic polyurethane, in particular for the production of vehicle interior components.

In a twelfth embodiment, the invention relates to an apparatus for performing a process according to any of embodiments 1 to 8, comprising:

an isocyanate reservoir vessel from which an isocyanate conduit for conveying a polyisocyanate stream departs, which isocyanate conduit opens into a first mixing device;
optionally a first conveying device assigned to the isocyanate conduit for conveying the polyisocyanate stream;
optionally a first mass flow meter connected to the isocyanate conduit;
a polyol reservoir vessel from which a polyol conduit for conveying a polyol stream departs, which polyol conduit opens into the first mixing device, where the polyol conduit is especially merged with the isocyanate conduit upstream of the first mixing device;
optionally a second conveying device assigned to the polyol conduit for conveying the polyol stream;
optionally a second mass flow meter connected to the polyol conduit;
a circulation feed conduit for conveying a mixed stream which exits from the first mixing device, which circulation feed conduit opens into a circulation conduit for conveying the circulation stream and chemically reacting the components of the circulation stream with the components of the mixed stream;
wherein the circulation conduit preferably comprises, in flow direction, a second mixing device, a temperature-controllable mixing device and a temperature-controllable conveying device;
a prepolymer feed conduit for conveying a prepolymer stream, which departs from the circulation conduit and opens into an extruder at the inlet side;
a pressure control valve provided in the prepolymer feed conduit for regulating the pressure of the prepolymer stream;
a three-way valve which is arranged in the prepolymer feed conduit and especially downstream of the pressure control valve, and from which a waste conduit which opens into a waste vessel departs, via which waste conduit the prepolymer stream can be guided wholly or partly into the waste vessel, especially in the event of startup, shutdown or a fault in the apparatus;
a venting device which is preferably arranged at the opening of the prepolymer feed conduit into the extruder for removal of gases and gaseous byproducts from the prepolymer stream;
an isocyanate feed conduit which departs from the isocyanate reservoir vessel or isocyanate conduit and opens into the extruder, preferably downstream of the prepolymer feed conduit in the working direction of the extruder, for conveying an isocyanate feed stream; a third conveying device assigned to the isocyanate feed conduit for conveying the isocyanate feed stream;
optionally a third mass flow meter connected to the isocyanate feed conduit;
wherein the extruder is suitable for reaction of the components of the prepolymer stream with the components of the isocyanate feed stream to give a thermoplastic polyurethane, and this has an assigned devolatilization shaft for removal of gases and gaseous byproducts by means of reduced pressure from this reaction, wherein the devolatilization shaft is preferably arranged in the last third of the extruder in the working direction of the extruder;
optionally a cooling device arranged beyond the outlet from the extruder, preferably a water bath, for cooling of the thermoplastic polyurethane to a temperature below its melting point;
optionally a comminution device that adjoins the cooling device, for comminution of the cooled thermoplastic polyurethane.

In a thirteenth embodiment, the invention relates to an apparatus according to embodiment 12, wherein, as first conveying device and/or as second conveying device, independently of one another, an annular gear pump is used and/or, as temperature-controllable conveying device, a gear pump is used.

In a fourteenth embodiment, the invention relates to an apparatus according to either of embodiments 12 and 13, wherein, as first and/or second mixing device and/or as temperature-controllable mixing device, independently of one another, a static mixer is used.

In a fifteenth embodiment, the invention relates to an apparatus according to any of embodiments 12 to 14, wherein the circulation conduit consists of jacketed conduits heatable with a heating medium, wherein preferably the second mixing device, the temperature-controllable mixing device and the temperature-controllable conveying device are also heatable with a heating medium.

In a sixteenth embodiment, the invention relates to an apparatus according to embodiment 15, wherein the heating medium is suitable for a heating temperature of 160° C. to 220° C., preferably of 170° C. to 190° C.

In a seventeenth embodiment, the invention relates to an apparatus according to any of embodiments 12 to 16, wherein the extruder is a planetary roller extruder or a screw extruder, wherein the extruder is preferably a co-rotating twin-screw extruder.

In an eighteenth embodiment, the invention relates to a thermoplastic polyurethane which has a mass-average molecular weight of 50 000 g/mol to 70 000 g/mol determined by gel permeation chromatography, in which the sample was dissolved in a solution of potassium trifluoroacetate in hexafluoroisopropanol at a concentration of 2 mg/cm³ and a polymethylmethacrylate standard was used, and an enthalpy of fusion ΔH_{fus} of 60 J/g to 100 J/g determined by differential thermal analysis in accordance with DIN EN ISO 11357-1:2017-02 at a heating rate of 10 K/min in the range from 20° C. to 250° C., wherein M_{w}=ΔH_{fus}*f, where f is a number from 600 to 900, preferably from 625 to 900, more preferably from 650 to 850, more preferably still from 700 to 850.

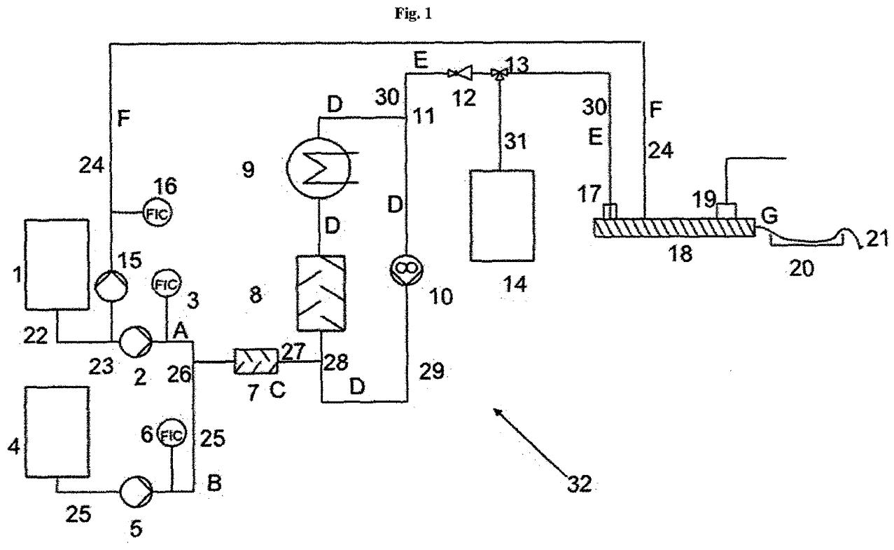

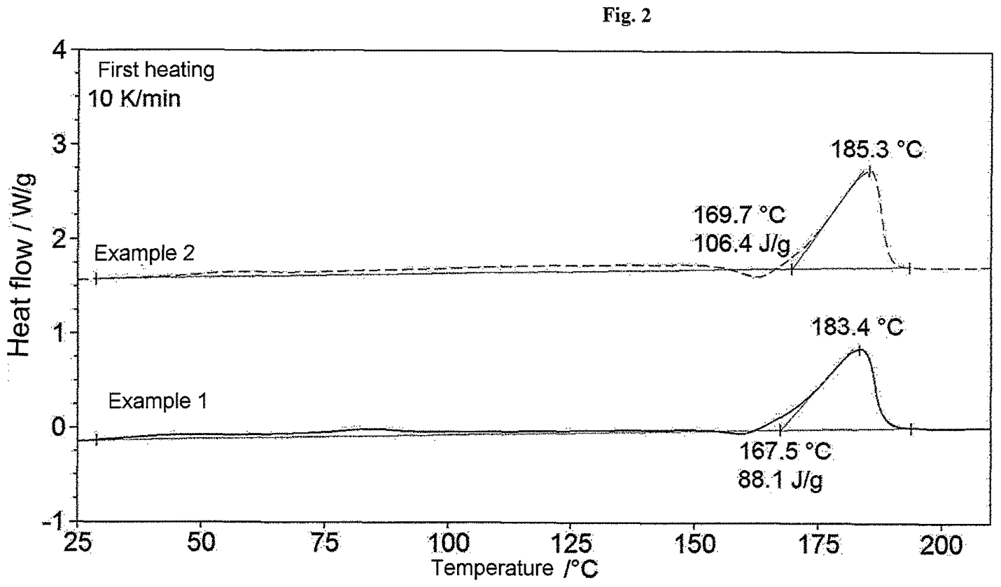

The present invention is more particularly elucidated hereinbelow with reference to FIGS. 1 and 2. These figures show:

FIG. 1 shows an apparatus for performing the process according to the invention, and

FIG. 2 shows a thermogram from a differential thermal analysis of a polyurethane that had been prepared by the process according to the invention and of a polyurethane that had been prepared by a different process.

FIG. 1 depicts an apparatus 32 for preparing thermoplastic polyurethane G by the process according to the invention. The apparatus comprises an isocyanate reservoir vessel 1, from which an isocyanate conduit 22 for conveying a polyisocyanate stream departs, the latter being divided into a polyisocyanate stream A and a polyisocyanate stream F at a first junction 23. The polyisocyanate stream A is fed, downstream of the first junction 23, by means of a first conveying device 2 to a first mixing device 7, in the present case a static mixer, the mass flow rate of the polyisocyanate stream A being monitored by means of a first mass flow meter 3.

The apparatus 32 further comprises a polyol reservoir vessel 4, from which a polyol conduit 25 departs, the latter serving to feed a polyol stream B to the first mixing device 7. Polyol conduit 25 has a second conveying device 5 and is connected to a second mass flow meter 6.

Upstream of the mixing device 7, the isocyanate conduit 22 and the polyol conduit 25 are merged at a second junction 26, with the result that the polyisocyanate stream A and the polyol stream B are fed to the mixing device 7 together.

From the first mixing device 7 departs a circulation feed conduit 27, through which a mixed stream C is fed to a third junction 28, from where it is circulated as a circulation stream D in a circulation conduit 29, the components of the circulation stream D chemically reacting with the components of mixed stream C in the process. The mass flow rates of the polyisocyanate stream A and the polyol stream B are adjusted such that there are stoichiometrically more OH groups than isocyanate groups, with the result that an OH-functional polyurethane prepolymer is formed in the circuit line 29. Circulation conduit 29 comprises, in flow direction, a second mixing device 8, in the present case a static mixer, a temperature-controllable mixing device 9 and a temperature-controllable conveying device 10. The temperature-controllable mixing device 9 is preferably suitable for removing heat of reaction. The temperature rise which is caused by the thermal energy released during the reaction of the components of the circulation stream D and of the mixed stream C can be controlled via the circulation regime.

From the circulation conduit 29, at a fourth junction 11 positioned between the temperature-controllable mixing device 9 and the temperature-controllable conveying device 10, a prepolymer stream E is separated as a substream from the circulation stream D and is fed via a prepolymer feed conduit 30 to the inlet side of an extruder 18 which in the present case is designed as a twin-screw extruder. The pressure prevailing in the prepolymer feed conduit 30 can be controlled by means of a pressure control valve 12. Downstream of the pressure control valve 12 in the prepolymer feed conduit 30 is positioned a three-way valve 13, from which a waste conduit 31 departs, which opens into a waste vessel 14. Via waste conduit 31, prepolymer stream E can be guided wholly or partly into the waste vessel 14 in the event of startup, shutdown or a fault in the apparatus 32.

A venting device 17 is provided at the opening of the prepolymer feed conduit 30 into the extruder 18 for removal of gases and gaseous byproducts from the prepolymer stream E. Downstream of the prepolymer feed conduit 30 in the working direction of the extruder, the extruder 18 has a junction for an isocyanate feed conduit 24 which, proceeding from a first junction 23 located on the isocyanate conduit 22 upstream of the first conveying device 2, feeds the isocyanate feed stream F from the isocyanate reservoir vessel 1 to the extruder 18 by means of the third conveying device 15. The mass flow in the isocyanate feed conduit 24 is monitored by means of a third mass flow meter 16. In the extruder 18, the prepolymer stream E is chemically reacted with the isocyanate feed stream F to give the thermoplastic polyurethane G. Extruder 18 has an assigned devolatilization shaft 19 for removal of gases and gaseous byproducts by means of a negative pressure from this reaction, which is arranged in the last third of extruder 18 in the working direction of the extruder. Beyond the outlet of extruder 18 is provided a cooling device 20 for cooling of thermoplastic polyurethane G to a temperature below its melting point. Cooling device 20 is adjoined by a comminution device 21 for comminution of the cooled thermoplastic polyurethane G.

### EXAMPLES

The present invention is elucidated further by the examples that follow, but without being restricted thereto.

Two thermoplastic polyurethanes, which were produced by different synthesis methods, were compared with one another, during which the enthalpy of fusion and the molecular weight of these two polyurethanes were analyzed.

### Determination of the Enthalpy of Fusion

The enthalpy of fusion is determined by means of differential scanning calorimetry (DSC) on the basis of DIN EN ISO 11357-1:2017-02. The measurement was effected on a Q1000 instrument (TA Instruments). Two heatings and a cooling in the range from 20° C. to 250° C. with a heating/cooling rate of 10 K/min were performed. The sample mass was about 6 mg. The purge gas flow (nitrogen) was 50 ml/min.

The enthalpy of fusion was determined by integrating the area above the glass transition temperature up to about 10° C. above the end of the melting peak.

### Determination of the Molecular Weight

GPC method for the determination of Mₙ and M_{w}:

The number-average and the mass-average molar mass were determined using gel permeation chromatography (GPC), in which the sample to be analyzed was dissolved in a solution of potassium trifluoroacetate in hexafluoroisopropanol at a concentration of 2 mg/cm³ and a polymethylmethacrylate standard was used.
Pump: 515 HPLC pump (Waters GmbH)
Detector: Smartline 2300 RI detector (Knauer Wissenschaftliche Geräte GmbH)
Columns: 1 precolumn, 1000 Å PSS PFG 7 μm, 300 Å PSS PFG 7 μm, 100 Å PSS PFG 7 μm in this sequence (PSS Polymer Standards Service GmbH)
Degassing: PSS Degasser (PSS Polymer Standards Service GmbH)
Injection volume: 100 microliters
Temperature: 23° C.-25° C.
Molar mass standard: Polymethylmethacrylate standard kit (PSS Polymer Standards Service GmbH)

Unless explicitly stated otherwise, in the present invention, the centrifuge-average molar mass M_{z} was determined by means of gel permeation chromatography (GPC) using polymethylmethacrylate as standard. The sample to be analyzed was dissolved in a solution of 3 g of potassium trifluoroacetate in 400 cubic centimeters of hexafluoroisopropanol (sample concentration about 2 mg/cubic centimeter), and then applied via a pre-column at a flow rate of 1 cubic centimeter/minute and then separated by means of three series-connected chromatography columns, first by means of a 1000 Å PSS PFG 7 μm chromatography column, then by means of a 300 Å PSS PFG 7 μm chromatography column and lastly by means of a 100 Å PSS PFG 7 μm chromatography column The detector used was a refractive index detector (RI detector). The mass-average molecular weight was calculated from the data obtained by the gel permeation chromatography measurement with the aid of the following equation:

$${\overline{M}}_{w} = \frac{{\sum }_{i} {n}_{i} {M}_{i}^{2}}{{\sum }_{i} {n}_{i} {M}_{i}} in g / mol$$

in which:

Mᵢ is the molar mass of the polymers of the fraction i, such that Mᵢ<Mᵢ₊₁ for all i, in g/mol, nᵢ is the molar amount of the polymer of the fraction i, in mol.

### Example 1 according to the Invention

An annular gear pump 2 (HNP, MZR 7255) was used to convey a polyisocyanate stream A consisting of hexamethylene 1,6-diisocyanate from a 250 liter reservoir 1 for hexamethylene 1,6-diisocyanate to a static mixer 7. The throughput of the polyisocyanate stream A was measured using a mass flow meter 3 (Bronkhorst, Mini Cori-Flow MIX, max. flow rate 12 kg/h). The temperature of the hexamethylene 1,6-diisocyanate was room temperature.

An annular gear pump 5 (HNP, MZR 7205) was used to convey a polyol stream B consisting of butane-1,4-diol from a 250 liter reservoir 4 for butane-1,4-diol to the static mixer 7. The throughput of the polyol stream B was measured using a mass flow meter 6 (Bronkhorst, Mini Con-Flow M1X, max. flow rate 8 kg/h). The temperature of the butane-1,4-diol was 40° C.

In the static mixer 7 (Sulzer SMX, diameter 6 mm, ratio of length to diameter L/D=10), polyisocyanate stream A and polyol stream B were mixed with one another so as to obtain a mixed stream C. The mass flow rates of the polyisocyanate stream A and of the polyol stream B were adjusted such that the isocyanate index in the mixed stream C was 78.

Mixed stream C was fed via a junction 28 into the circulation conduit 29 in which a circulation stream D was circulated. Downstream of the junction 28, the circulation stream D was guided into a static mixer 8 (static mixer equivalent to Sulzer SMX, internal diameter 34 mm, L/D=20). The temperature of prepolymer stream D was 182° C.

Downstream of static mixer 8, circulation stream D was guided into a temperature-controllable static mixer 9. The oligomerization of the circulation stream D with the mixed stream C took place there for the most part and the heat of reaction formed was removed. The temperature-controllable static mixer 9 was of similar construction to a Sulzer SMR reactor with internal crossed tubes. It had an internal volume of 1.9 liters and a heat exchange surface area of 0.44 square meters. It was heated/cooled with heat-transfer oil. The heating medium temperature at the inlet was 180° C.

The circulation stream D exited the temperature-controllable static mixer 9 at a temperature of 183° C. Downstream of the temperature-controllable static mixer 9, a prepolymer stream E was separated from circulation stream D at a junction 11, and the circulation stream D was guided onward to a gear pump 10. The prepolymer stream E was guided into an extruder 18.

The pressure of circulation stream D was increased in a gear pump 10. The gear pump 10 (Witte Chem 25,6-3) had a volume per revolution of 25.6 cubic centimeters and a speed of 50 revolutions per minute. Circulation stream D was combined with mixed stream C downstream of the pump at junction 28, as already described.

Circulation conduit 29 consisted of jacketed pipe conduits heated with thermal oil. The heating medium temperature was 182° C. The static mixer 8, the temperature-controllable static mixer 9 and the gear pump 10 consisted of apparatuses heated with thermal oil. The heating medium temperature was 182° C.

The reactive extrusion was conducted in an extruder 18 at a temperature of 200° C. and a speed of 66 revolutions per minute. The extruder 18 was a ZSK 26 MC from Coperion, with a screw diameter of 26 mm and a length to diameter ratio of 36 to 40.

The extruder 18 had a venting means 17 that was operated at a negative pressure of about 1 mbar relative to standard pressure, and in which prepolymer stream E was freed of any inert gases entrained with the polyisocyanate stream A and the polyol stream B, and possible gaseous reaction products.

A micro annular gear pump 15 (MZR 6355 from HNP) was used to withdraw an isocyanate feed stream F consisting of hexamethylene 1,6-diisocyanate from reservoir 1. The throughput of the isocyanate feed stream F was measured by means of a mass flow meter 16 (Bronkhorst, Mini Cori-Flow MIX, maximum flow rate 2 kg/h). The temperature of the hexamethylene 1,6-diisocyanate was room temperature. Isocyanate feed stream F was guided into the extruder 18 downstream of prepolymer stream E. In the extruder 18, the prepolymer stream E was reacted with the isocyanate feed stream F at an isocyanate index of 99 to give a thermoplastic polyurethane G.

A devolatilizer 19 arranged in the last third of the extruder 18 in flow direction was used to free the thermoplastic polyurethane G of volatile constituents at 200 mbar below standard pressure with the aid of a vacuum dome arranged on top of a devolatilization shaft of the extruder. The thermoplastic polyurethane G after exiting from the extruder 18 through two nozzles was cooled in a water bath 20 filled with deionized water (DM water) and chopped into pellets by means of a pelletizer 21.

TABLE 1
Material streams in the preparation of the TPU in example 1

| | [kg/h] |
|---|---|
| Stream A (HDI) | 2.911 |
| Stream B (BDO) | 2.000 |
| Stream J (HDI) | 0.784 |
| Stream E (prepolymer) | 120 |

### Reference Example 2

In a stirred tank (250 ml), 24.59 g of butane-1,4-diol was heated to 90° C. while stirring (170 revolutions per minute (rpm)) and with introduction of nitrogen, for 30 minutes. Subsequently, 45.39 g of HDI was metered continuously into the butanediol over a period of 45 minutes. In the course of this, the temperature of the reaction mixture was increased constantly by 4° C. per minute until a temperature of 190° C. had been attained (25 minutes). As soon as a product temperature of 190° C. had been attained, the stirrer speed was increased to 300 rpm. The temperature in the stirred tank was kept constant between 190° C. and 200° C.

After the metered addition of HDI had ended, the melt was stirred for a further 5 minutes. Subsequently, it was poured into an aluminum mold in the hot state.

### Results

The enthalpy of fusion and the molecular weights of the thermoplastic polyurethanes obtained from examples 1 and 2 were analyzed by the methods described above. The results are compiled in table 2:

TABLE 2
Enthalpy of fusion and molecular weight
of the polyurethanes obtained

| | Example 1 according | Comparative |
|---|---|---|
| | to the invention | example 2 |
| Enthalpy of fusion ΔH_{fus} [J/g] | 88.1 | 106.4 |
| Melting temperature [C°] | 183.4 | 185.3 |
| M_{w} [g/mol] | 58510 | 60020 |
| M_{w}/Mₙ | 4.97 | 2.55 |
| M_{z}/M_{w} | 2.71 | 2.05 |
| f | 664 | 564 |

f=M_{w}/ΔH_{fus}

The DSC thermograms of the two materials analyzed are shown in FIG. 2. The thermoplastic polyurethanes from examples 1 and 2 each have a mass-average molecular weight in a similar range of 58 000 g/mol to approx. 60 000 g/mol and also have similar melting temperatures in the range from 183° C. to 186° C. However, the TPU according to the invention has an enthalpy of fusion that is 17.2% lower compared to the TPU of the comparative example. Due to the lower enthalpy of fusion of the TPU according to the invention, in the further processing by melting and subsequent shaping less energy needs to be supplied for the melting than for the further processing of the TPU from the comparative example. If the same amount of energy is used to melt the thermoplastic polyurethanes from the examples, the TPU according to the invention melts quicker.

### LIST OF REFERENCE SYMBOLS

(A) polyisocyanate stream

(B) polyol stream

(C) mixed stream

(D) circulation stream

(E) prepolymer stream

(F) isocyanate feed stream

(G) thermoplastic polyurethane

(1) isocyanate reservoir vessel

(2) first conveying device

(3) first mass flow meter

(4) polyol reservoir vessel

(5) second conveying device

(6) second mass flow meter

(7) first mixing device

(8) second mixing device

(9) temperature-controllable mixing device

(10) temperature-controllable conveying device

(11) fourth junction

(12) pressure control valve

(13) three-way valve

(14) waste vessel

(15) third conveying device

(16) third mass flow meter

(17) venting device

(18) extruder

(19) devolatilization shaft

(20) cooling device

(21) comminution device

(22) isocyanate conduit

(23) first junction

(24) isocyanate feed conduit

(25) polyol conduit

(26) second junction

(27) circulation feed conduit

(28) third junction

(29) circulation conduit

(30) prepolymer feed conduit

(31) waste conduit

(32) apparatus

1. A process for preparing a thermoplastic polyurethane by means of reactive extrusion, comprising:
a) mixing a polyisocyanate stream and a polyol stream in a first mixing device to obtain a mixed stream, wherein the mass flow rates of the polyisocyanate stream and of the polyol stream are adjusted such that the isocyanate index in the mixed stream is from 55 to 85,
b) introducing the mixed stream into a circulation stream which is circulated, wherein the monomers of the polyisocyanate stream and of the polyol stream (B) react further in the circulation stream to give OH-functional prepolymers,
c) separating a prepolymer stream from the circulation stream and introducing the prepolymer stream into an extruder,
d) introducing an isocyanate feed stream into the extruder downstream of the introduction of the prepolymer stream in the working direction of the extruder, wherein the introduction is such that the OH-functional prepolymers present in the prepolymer stream and the polyisocyanate present in the isocyanate feed stream are in an isocyanate index of 85 to 120 with respect to one another,
e) reacting the prepolymer stream with the isocyanate feed stream in the extruder to obtain the thermoplastic polyurethane as extrudate.

2. The process as claimed in claim 1, wherein the polyisocyanate stream and/or the isocyanate feed stream comprise hexamethylene 1,6-diisocyanate, wherein in particular the polyisocyanate stream (A) and the isocyanate feed stream (F) contain or consist of hexamethylene 1,6-diisocyanate.

3. The process as claimed in claim 1, wherein the polyol stream (B) comprises butane-1,4-diol.

4. The process as claimed in claim 1, wherein, prior to the introduction of the prepolymer stream into the extruder, gases and gaseous byproducts are removed from the prepolymer stream (E), preferably by passing the prepolymer stream (E) through a venting device (17) at a negative pressure of 0.1 mbar to 10 mbar below standard pressure, wherein the venting device (17) is preferably arranged on the extruder (18).

5. The process as claimed in claim 1, wherein the reaction in step e) is conducted at a temperature of 150° C. to 220° C., preferably of 180° C. to 200° C.

6. The process as claimed in claim 1, wherein gases and gaseous byproducts are removed from the thermoplastic polyurethane by applying a negative pressure of 50 mbar to 500 mbar below standard pressure at a devolatilization shaft which is preferably arranged in the last third of the extruder in the working direction of the extruder.

7. The process as claimed in claim 1, wherein the process further comprises:
f) cooling the thermoplastic polyurethane below a melting point of the thermoplastic polyurethane in a cooling device, and
g) comminuting the thermoplastic polyurethane in a comminution device.

8. A thermoplastic polyurethane obtained by a process as claimed in claim 1.

9. The thermoplastic polyurethane as claimed in claim 8, wherein the thermoplastic polyurethane has:
a mass-average molecular weight M_{w} of 50 000 g/mol to 70 000 g/mol determined by gel permeation chromatography, in which the sample was dissolved in a solution of potassium trifluoroacetate in hexafluoroisopropanol at a concentration of 2 mg/cm³ and a polymethylmethacrylate standard was used, and
an enthalpy of fusion ΔH_{fus} of 60 J/g to 100 J/g determined by differential scanning calorimetry in accordance with DIN EN ISO 11357-1:2017-02 at a heating rate of 10 K/min in the range from 20° C. to 250° C., wherein M_{w}=ΔH_{fus}*f, where f is a number from 600 to 900, preferably from 625 to 900, more preferably from 650 to 850, more preferably still from 700 to 850.

10. The use of a thermoplastic polyurethane as claimed in claim 8 in a shaping process involving melting of the thermoplastic polyurethane, in particular for the production of vehicle components.

11. An apparatus for performing a process as claimed in claim 1, comprising:
an isocyanate reservoir vessel from which an isocyanate conduit for conveying a polyisocyanate stream departs, which isocyanate conduit opens into a first mixing device;
a polyol reservoir vessel from which a polyol conduit for conveying a polyol stream departs, which polyol conduit opens into the first mixing device, where the polyol conduit is especially merged with the isocyanate conduit upstream of the first mixing device;
a circulation feed conduit for conveying a mixed stream which exits from the first mixing device, which circulation feed conduit opens into a circulation conduit for conveying the circulation stream and chemically reacting the components of the circulation stream with the components of the mixed stream;
wherein the circulation conduit preferably comprises, in flow direction, a second mixing device, a temperature-controllable mixing device and a temperature-controllable conveying device;
a prepolymer feed conduit for conveying a prepolymer stream, which departs from the circulation conduit and opens into an extruder at the inlet side;
a pressure control valve provided in the prepolymer feed conduit for regulating the pressure of the prepolymer stream;
a three-way valve which is arranged in the prepolymer feed conduit and especially downstream of the pressure control valve, and from which a waste conduit which opens into a waste vessel departs, via which waste conduit the prepolymer stream can be guided wholly or partly into the waste vessel, especially in the event of startup, shutdown or a fault in the apparatus;
a venting device which is preferably arranged at the opening of the prepolymer feed conduit into the extruder for removal of gases and gaseous byproducts from the prepolymer stream;
an isocyanate feed conduit which departs from the isocyanate reservoir vessel or isocyanate conduit and opens into the extruder, preferably downstream of the prepolymer feed conduit in the working direction of the extruder, for conveying an isocyanate feed stream;
wherein the extruder is suitable for reaction of the components of the prepolymer stream with the components of the isocyanate feed stream to give a thermoplastic polyurethane, and this has an assigned devolatilization shaft for removal of gases and gaseous byproducts by means of reduced pressure from this reaction, wherein the devolatilization shaft is preferably arranged in the last third of the extruder in the working direction of the extruder;
optionally a cooling device arranged beyond the outlet from the extruder, preferably a water bath, for cooling of the thermoplastic polyurethane to a temperature below its melting point;
optionally a comminution device that adjoins the cooling device, for comminution of the cooled thermoplastic polyurethane.

12. The apparatus as claimed in claim 11, wherein, as first conveying device and/or as second conveying device, independently of one another, an annular gear pump is used and/or, as temperature-controllable conveying device, a gear pump is used.

13. The apparatus as claimed in claim 11, wherein, as first and/or second mixing device and/or as temperature-controllable mixing device, independently of one another, a static mixer is used.

14. The apparatus as claimed in claim 11, wherein the circulation conduit consists of jacketed conduits heatable with a heating medium, wherein preferably the second mixing device, the temperature-controllable mixing device and the temperature-controllable conveying device are also heatable with a heating medium, wherein the heating medium is preferably suitable for a heating temperature of 160° C. to 220° C.

15. The apparatus as claimed in claim 11, wherein the extruder is a planetary roller extruder or a screw extruder, wherein the extruder is preferably a co-rotating twin-screw extruder.

16. A thermoplastic polyurethane having:
a mass-average molecular weight M_{w} of 50 000 g/mol to 70 000 g/mol determined by gel permeation chromatography, in which the sample was dissolved in a solution of potassium trifluoroacetate in hexafluoroisopropanol at a concentration of 2 mg/cm³ and a polymethylmethacrylate standard was used, and
an enthalpy of fusion ΔH_{fus} of 60 J/g to 100 J/g determined by differential thermal analysis in accordance with DIN EN ISO 11357-1:2017-02 at a heating rate of 10 K/min in the range from 20° C. to 250° C., wherein M_{w}=ΔH_{fus}*f, where f is a number from 600 to 900, preferably from 625 to 900, more preferably from 650 to 850, more preferably still from 700 to 850.
